(19) United States
(12) Patent Application Publication
(10) Pub. No.: US 2026/0139396 A1
(43) Pub. Date: May 21, 2026

(54) Green Hydrogen Production Process (GHPP)

(71) Applicant: Element Resources Inc., Houston, TX (US)

(72) Inventors: Steven Meheen, Houston, TX (US); Ian Dunderdale, Houston, TX (US); Adele Perrier Ramos, Houston, TX (US); Craig Branch, London (GB)

(21) Appl. No.: 19/392,775

(22) Filed: Nov. 18, 2025

Related U.S. Application Data
(60) Provisional application No. 63/722,424, filed on Nov. 19, 2024.

(51) Int. Cl. C25B 15/02; C25B 1/04; C25B 9/65; C25B 15/08; F25J 1/00; F25J 1/02; H02J 3/38

(52) U.S. Cl. CPC C25B 15/02; C25B 1/04; C25B 9/65; C25B 15/08; F25J 1/001; F25J 1/0249; H02J 3/38; F25J 2260/30; H02J 2101/24

(57) ABSTRACT

The primary energy sources for low/zero carbon intensity (green) hydrogen production, such as sunlight and wind, are inherently intermittent in duration and variable in strength. An integrated, dynamically controlled production process is needed for the optimization of continuous green hydrogen production. The process needs to manage this dynamic state on a frequent basis within a green hydrogen production process to assess impacts from incoming renewable energy through to the outgoing continuous (e.g., 24 hours per day and up to 365 days per year) production of both gaseous and liquid hydrogen. The process needs to manage operational performance and metrics continuously using the production facility configuration, renewable energy supply profiles and operational safety requirements together with the capability to adapt to a variety of external constraints, including weather variation, water supply variation and offtake requirements.

### CROSS-REFERENCE TO RELATED APPLICATIONS

This application claims the benefit of priority under 35 U.S.C. § 119(e) to U.S. Provisional patent application Ser. No. 63/722,424, titled “Green Hydrogen Production Process (GHPP),” and filed Nov. 19, 2024, the entire contents of which are incorporated herein by reference.

### FIELD OF THE INVENTION

Optimized process (method) for the effective utilization of intermittent and variable power supply from renewable or other power sources. This may be applied to the production of low carbon intensity hydrogen and other industrial gases and industrial processes. This process can use electricity supplied by intermittent sources. Intermittent sources include off-grid renewable energy (solar, wind, etc.), un-utilized nuclear, and geo-thermal energy sources. For example, intermittent power may be utilized to electrolyze water and produce both gaseous and liquid hydrogen and/or other products on a continuous basis.

### BACKGROUND

Currently, hydrogen is primarily produced by Steam Methane Reforming (SMR). Hydrogen produced via SMR is commonly referred to as Grey Hydrogen. It requires energy, usually from fossil fuels, to reform methane from natural gas into hydrogen and carbon dioxide. This results in a high carbon intensity of the product(s), whereas the utilization of the noted intermittent power supply(s) produces a very low carbon intensity product. This low carbon intensity product is known as Green Hydrogen.

### BRIEF SUMMARY

The present disclosure provides systems and methods of industrial production from intermittent power sources on a continuous basis (e.g., 24 hours per day operation and up to 365 days per year). The invention uses renewable energy of intermittent availability. As applied to low carbon intensity hydrogen production, sufficient energy is provided to split water into hydrogen and oxygen on a continuous production basis. The oxygen may be safely returned to the atmosphere or captured and used for medical and industrial purposes.

Utilization of renewable energy source(s) does not produce greenhouse gas emissions, thereby resulting in low to zero carbon intensity in the finished product(s). Systems and methods are disclosed that are capable of continuous operation of industrial processes (such as those required to produce low/zero carbon intensity hydrogen) while optimizing operations for intermittent power supplies. The range of intermittent power supplies includes unutilized nuclear, geothermal, and off-grid energy supplies (e.g., solar, wind, etc.) and any combination thereof. As used herein the term “continuous” means 24 hours per day production of at least some hydrogen and up to 365 days per year depending upon downtime for routine maintenance and unplanned shutdowns due to, for example, unexpected equipment failure, material shortages, human error, software issues, and the like.

### BRIEF DESCRIPTION OF THE DRAWINGS

To easily identify the discussion of any particular element or act, the most significant digit or digits in a reference number refer to the figure number in which that element is first introduced.

FIG. 1 illustrates a production system 100 in accordance with one embodiment.

FIG. 2 illustrates a green hydrogen production process 200 in accordance with one embodiment.

FIG. 3 illustrates the length of nights for an exemplary facility 300 in accordance with one embodiment.

FIG. 4 illustrates a summer daytime power utilization profile for an exemplary facility 400 in accordance with one embodiment.

FIG. 5 illustrates an embodiment of a computational apparatus 500 to implement components and process steps of the system described herein.

FIG. 6 illustrates a cloud computing node 600 in accordance with one embodiment.

FIG. 7 illustrates a cloud computing system 700 in accordance with one embodiment.

FIG. 8 illustrates cloud computing functional abstraction layers 800 in accordance with one embodiment.

### DETAILED DESCRIPTION

The disclosed Green Hydrogen Production Process (GHPP) uses dedicated renewable energy from sources such as photovoltaic (PV) solar, wind energy, geothermal energy and nuclear energy for its power supply. It is therefore considered “off the grid” or behind the meter (BTM), and may operate in island mode, as it does not need to rely on power from public utilities or other outside sources. As used herein, the term “island mode” refers to operation independently from the main utility grid. In some embodiments, the GHPP may also be capable of connecting to the grid, and power from the grid may be used in conjunction with the one or more renewable energy sources. In some such embodiments, the power from the grid may be from one or more renewable energy sources as well. Consequently, in at least some embodiments, the process does not use or consume fossil fuels or produce greenhouse gas emissions.

In certain embodiments, the GHPP is an integrated process combining renewable energy (e.g., PV solar power), long duration battery energy storage, water electrolysis, and hydrogen liquefaction, with storage for both liquid and gaseous hydrogen. The GHPP and systems configured to perform the GHPP optimize intermittent energy supply through the use of battery energy to support continuous operation of electrolyzers and/or liquefaction trains at varying capacity for continuous hydrogen production (gaseous and/or liquefied). Off grid intermittent power generation driving optimized continuous hydrogen production and liquefaction has not been previously defined.

The GHPP has industrial applicability for the production of green hydrogen and other industrial products where there are sources of renewable energy that are typically available only on an intermittent basis but where there is a continuous demand for hydrogen and other industrial products. Examples may include hydrogen refueling for heavy duty truck haulage, public transportation operations, and fertilizer plant production.

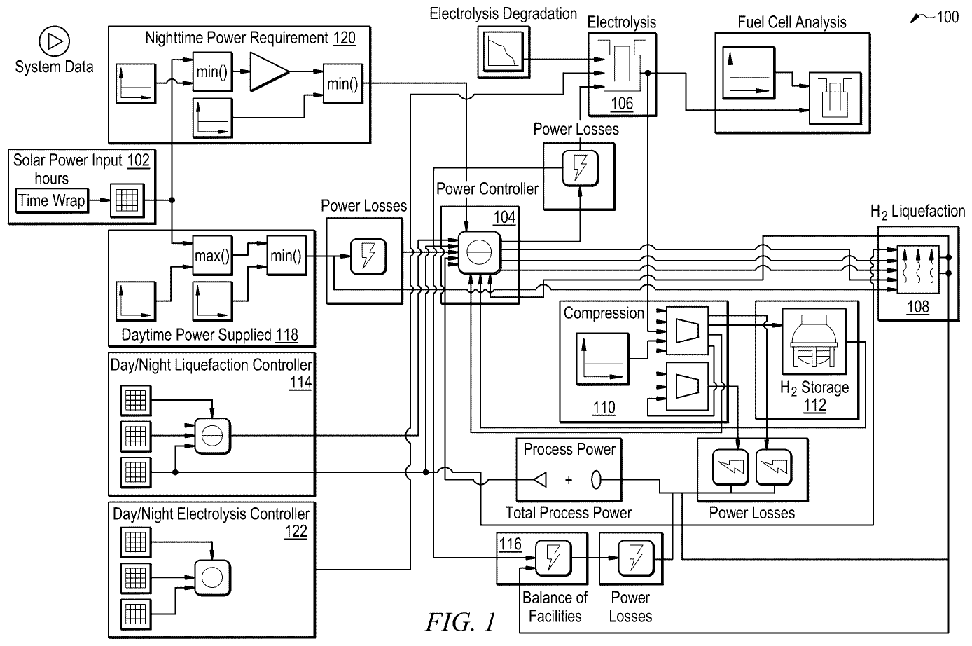

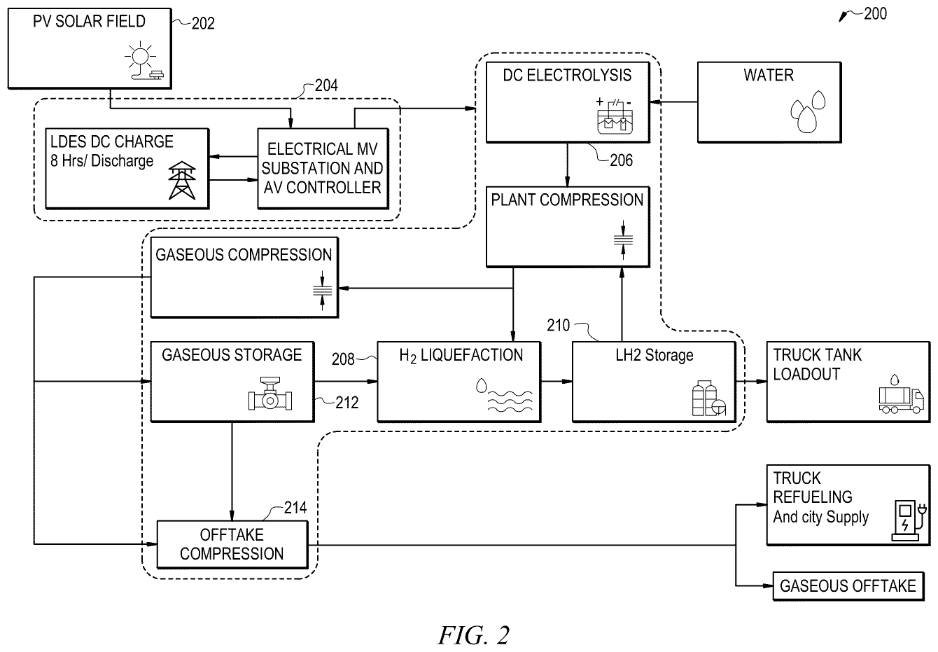

FIG. 1 illustrates a production system 100 in accordance with one embodiment. The production system 100 may be configured to perform the green hydrogen production process (GHPP) 200 disclosed herein and illustrated in and described with respect to FIG. 2. The production system 100 may comprise an intermittent renewable power input 102, a power controller 104 with power storage (e.g., a battery system), electrolysis 106, liquefaction 108, compression 110, gaseous hydrogen storage 112, a liquefaction controller 114, an electrolysis controller 122, and balance of facilities 116. With respect to FIG. 1, power loss elements are indicated at points in the production system 100 where power loss may be estimated to occur. In certain embodiments, as discussed in more detail below, a power balancing may be performed across the production system 100 to ensure that the daytime power supplied 118 is managed such that the nighttime power needed 120 to maintain continuous hydrogen production is provided (e.g., stored in the power storage). As used herein, the terms “daytime” and “nighttime” should not necessarily be interpreted to be limited to particular times of day and instead respectively refer to periods of time when more power (e.g., daytime) and when less (or no) power (e.g., nighttime) is available directly from the intermittent renewable power input 102.

The intermittent renewable power input 102 powers the equipment and processes of the production system 100 by using a renewable source of energy to generate electricity without producing greenhouse gas emissions. The intermittent renewable power input 102 may be directly or indirectly coupled to each piece of process equipment within the production system 100 (e.g., electrolysis 106, liquefaction 108, compression 110, gaseous hydrogen storage 112, balance of facilities 116, etc.) and to each piece of hardware that runs the controllers (e.g., power controller 104, liquefaction controller 114, electrolysis controller 122, etc.). In one embodiment, the renewable power input 102 may be solar power from a solar farm. Although solar power is referenced in the following descriptions and with respect to the figures, the production system 100 and GHPP 200 disclosed herein are not limited to using solar power as the input renewable power, and other sources of input renewable power (e.g., wind energy, geothermal energy and nuclear energy) and/or combinations thereof with and/or without solar power are possible and contemplated with respect to the invention disclosed herein.

In certain embodiments, the production system 100 may include a power controller 104 with power storage. In certain embodiments, the production system 100 may take intermittent renewable power input 102, such as solar input from a solar farm, and may use a power controller 104 with power storage to manage how the intermittent renewable power input 102 powers an industrial process, such as the GHPP. The power controller 104 and/or the power storage of the power controller 104 may be directly or indirectly coupled to the intermittent renewable power input 102, each piece of process equipment in the production system 100 (e.g., electrolysis 106, liquefaction 108, compression 110, gaseous hydrogen storage 112, balance of facilities 116, etc.), each piece of hardware that runs the individual controllers (e.g., liquefaction controller 114, electrolysis controller 122, etc.) through one or more wired or wireless connections. In certain embodiments, the power storage may be a long duration energy storage (e.g., greater than 300 MWh). In certain embodiments, the power storage may be one or more flow batteries (e.g. vanadium), one or more solid-state batteries (e.g., lithium-ion), thermal energy storage batteries (e.g., molten salt, heated rocks), and any combinations thereof.

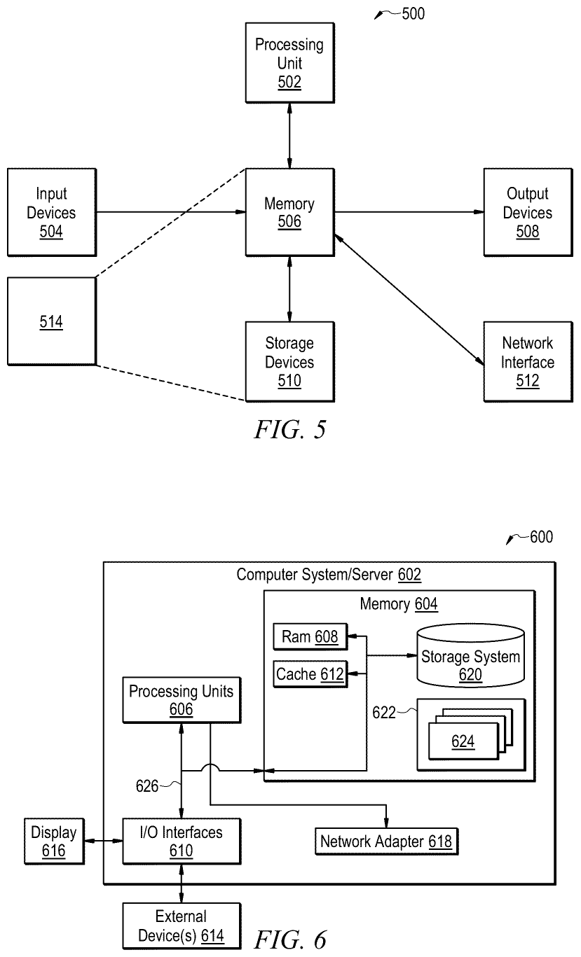

In certain embodiments, the power controller 104 may include a computational apparatus 500, or the power controller 104 may be embodied as a processing unit 502 of a computational apparatus 500 as described with respect to FIG. 5. In certain embodiments, the power controller 104 may include cloud computing node 600 or may be configured from the processing units 606 of a cloud computing node 600 supported by a cloud computing system 700, as described with respect to FIG. 6-FIG. 8. In certain embodiments, logic stored in directly accessible memory or cloud-based storage may configure such processors to act as the power controller 104 of the present disclosure.

In certain embodiments, the power controller 104 performs a balance equation across the whole production system 100, wherein the difference between the intermittent renewable power input 102 and the power consumed by the production system 100 to power the process equipment must balance to equal zero. In some embodiments, excess power from the intermittent renewable power input 102 that is not consumed by the production system 100 may be curtailed to maintain balance. In certain embodiments, the power into the production system 100 at the intermittent renewable power input 102 is measured using meters and inverters. In certain embodiments, the measuring and monitoring of the real-time intermittent renewable power input 102 is done at a time interval shorter than one second, including for real-time monitoring of the interface between the intermittent renewable power input 102 and each piece of process equipment that consumes power within the production system 100.

There is a simple cause and effect relationship throughout the production system 100 whereby gaseous hydrogen production from electrolysis 106 minus gaseous hydrogen to gaseous hydrogen storage 112 and gaseous hydrogen to offtake (e.g., via trailers, trucks, etc.) (not depicted) must equal gaseous hydrogen to liquefaction 108. Each piece of process equipment that consumes power within the production system 100 has a performance curve, which is a measure of power consumed versus percentage turndown. As used herein, the term “turndown” of a piece of equipment refers to a reduction in the control range (e.g., setpoint) of one or more of its operating process variables (e.g., flow or capacity), which may be achieved by adjusting its turndown setpoint (i.e., the ratio of its maximum to minimum operating process variables). The process equipment performance curves can be non-linear, i.e. power consumed=function (turndown). The power controller 104 solves each of these performance curves to determine the overall operating point (e.g., turndown setpoint) of each piece of process equipment to ensure balance is achieved across the production system 100. Overall, the system operates in island mode and the intermittent renewable power input 102 and the power consumed by the production system 100 are monitored by the power controller 104 to ensure stable overall operation. Each piece of process equipment is on a long-time scale and changes are undertaken over minutes (e.g., 1-5 minutes) or hours (e.g., 1-2 hours).

In certain embodiments, the main production processes for a facility housing the production system 100 may include electrolysis 106 which may include one or more electrolyzers for gaseous hydrogen production, a water system, and associated utilities, liquefaction 108 which may include one or more liquefaction trains for liquid hydrogen production and associated utilities, compression 110 which may include one or more compressors to compress gaseous hydrogen from electrolysis for storage in gaseous hydrogen storage 112, liquefaction 108, and/or offtake (not depicted). As discussed herein, these processes may be designed to operate continuously and may vary hydrogen production levels based on the yearly, seasonal, and daily solar power production profiles. In one embodiment, the power controller 104 may be directly or indirectly coupled to electrolysis 106 through one or more wired or wireless connections. As would be understood by one skilled in the art, the one or more electrolyzers in electrolysis 106 splits water molecules into hydrogen and oxygen resulting in the production of gaseous hydrogen. In one embodiment, the power controller 104 may be directly or indirectly coupled to liquefaction 108 through one or more wired or wireless connections. As would be understood by one skilled in the art, the one or more liquefaction trains in liquefaction 108 cools gaseous hydrogen from the one or more electrolyzers in electrolysis 106 to extreme cryogenic temperatures to convert it into liquid hydrogen. In one embodiment, the power controller 104 may be directly or indirectly coupled to compressor 110 through one or more wired or wireless connections. As would be understood by one skilled in the art, the one or more compressors in compression 110 may compress gaseous hydrogen from electrolysis 106 to an appropriate pressure for storage in gaseous hydrogen storage 112. Each piece of equipment in electrolysis 106, liquefaction 108, and compression 110 may be equipped with one or more sensors, including flow sensors, level sensors, pressure sensors, temperature sensors, and the like. Each piece of equipment in electrolysis 106, liquefaction 108, and compression 110 may have one or more controllers, such as flow controllers, level controllers, pressure controllers, and temperature controllers, associated with the one or more sensors. Each controller may include one or more setpoints for each process variable (e.g., flow, level, pressure, temperature) at which the controller attempts to maintain the process variable. As discussed below, the setpoint for the controllers may be adjusted to maintain continuous operation throughout the nighttime.

In certain embodiments, the production system 100 includes a liquefaction controller 114. The liquefaction controller 114 may appropriately control the process equipment in liquefaction 108 (e.g., one or more liquefaction trains) to perform the green hydrogen production process (GHPP) 200. In certain embodiments, the production system 100 includes an electrolysis controller 122. The electrolysis controller 122 may appropriately control the process equipment in electrolysis 106 (e.g., one or more electrolyzers) to perform the green hydrogen production process (GHPP) 200. In one embodiment, for the previous daytime operation, a known state of charge of the power storage of the power controller 104 (e.g., based on energy capacity (MWh)) and a known state of charge of the gaseous hydrogen storage 112 (e.g., based on pressure (equivalent mass)) may be observed and recorded by the power controller 104. From this information, as well as the known number of operating liquefaction trains in liquefaction 108, a production rate or “turndown” setpoint for electrolysis 106 and liquefaction 108 needed to allow the production system 100 to operate continuously throughout the nighttime without draining the power storage or depleting the gaseous hydrogen storage 112 may be calculated. A turndown setpoint for each of the electrolyzers and the liquefaction trains, as based on at least one of these two states of charge, may then be selected. Once these desired conditions (e.g., number of liquefaction trains and the turndown setpoint) are known, operating setpoints (e.g., for flow, level, pressure, and/or temperature) may be determined and provided by individual controllers (e.g., liquefaction controller 114, electrolysis controller 122) to their respective process equipment (e.g., one or more liquefaction trains in liquefaction 108 and the one or more electrolyzers in electrolysis 106, respectively) based upon the turndown setpoint determined by the power controller 104 in order to transition from daytime operation to nighttime operation or to otherwise implement turndown operations (e.g., based on predictive data as discussed below).

In certain embodiments, the electrolysis controller 122 may be pre-programmed to perform a known transition operation. In certain embodiments, the same pre-programmed, known transition operations may be performed by the electrolysis controller 122 upon a transition from nighttime to daytime operation and from daytime to nighttime operation. For example, in one embodiment, the electrolysis controller 122 may be pre-programmed to ramp down the operation of the electrolysis 106, including the one or more electrolyzers, to completely shut down upon a transition of daytime operation to nighttime operation. In another embodiment, the electrolysis controller 122 may be pre-programmed to ramp up the operation of the electrolysis 106, including the one or more electrolyzers, to bring the electrolysis 106 back into operation at a pre-programmed operational setpoint upon a transition from nighttime to daytime operation. In another embodiment, the liquefaction controller 116 may be pre-programmed to ramp down the operation of an electrolyzer within electrolysis 106 over a set period of time (e.g., over about 5 to about 10 minutes), depending on, for example, the equipment and operating parameters, to a specific operation setpoint for a first process variable (e.g., flow) based on the turndown setpoint determined by the power controller 104 and may further be pre-programmed to adjust operation setpoints for other process variables (e.g., level, temperature, pressure) based on the operation setpoint for the first process variable (e.g., flow).

In certain embodiments, the liquefaction controller 114 may be pre-programmed to perform a known transition operation. In certain embodiments, the same pre-programmed, known transition operations may be performed by the liquefaction controller 114 upon a transition from nighttime to daytime operation and from daytime to nighttime operation. For example, in one embodiment, the liquefaction controller 116 may be pre-programmed to ramp down the operation of a liquefaction train within liquefaction 108 to completely shut down upon a transition of daytime operation to nighttime operation. In another embodiment, the liquefaction controller 116 may be pre-programmed to ramp up the operation of a liquefaction train within liquefaction 108 to bring the liquefaction 108 back into operation at a pre-programmed operational setpoint upon a transition from nighttime to daytime operation. In another embodiment, the liquefaction controller 116 may be pre-programmed to ramp down the operation of a liquefaction train within liquefaction 108 over a set period of time (e.g., over about 5 to about 10 minutes), depending on, for example, the equipment and operating parameters, to a specific operation setpoint for a first process variable (e.g., flow) based on the turndown setpoint determined by the power controller 104 and may further be pre-programmed to adjust operation setpoints for other process variables (e.g., level, temperature, pressure) based on the operation setpoint for the first process variable (e.g., flow). As would be appreciated by one of skill in the art, the specific details of these transitions from one operating point to another would be established for a particular system and process during the detailed design and commissioning phases.

In certain embodiments, the production system 100 may include facility power balancing performed by power controller 104. Although the following description of facility power balancing is described with respect to certain embodiments of the production system 100 in which solar power is used as the intermittent renewable power input 102, other forms of intermittent renewable power are contemplated and may undergo facility power balancing when used as the intermittent renewable power input 102 of the production system 100. Facility power balancing is performed to ensure that the intermittent renewable power input 102 is managed during periods when the power directly from the renewable source (e.g., solar power from a solar farm) is available such that the power needs are met during periods when the power directly from the renewable source is not available (e.g., at nighttime in the case of solar). For example, in certain embodiments, facility power balancing is performed by power controller 104 to ensure that the daytime power supplied 118 is managed such that the nighttime power needed 120 to maintain continuous hydrogen production is provided (e.g., stored in the power storage).

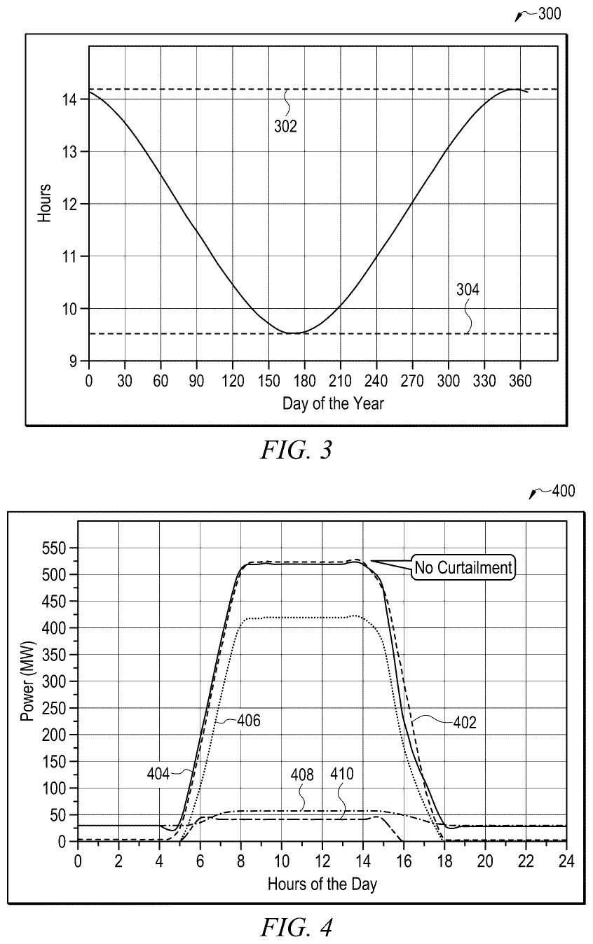

During the day, facility power balancing performed by power controller 104 may optimize the use of daytime power supplied 118 from the intermittent renewable power input 102 by prioritizing charging the power storage (e.g., the battery) of the power controller 104, powering electrolysis 106 and compression 110 in order to store gaseous hydrogen in gaseous hydrogen storage 112, and providing power to the balance of facilities 116 (e.g., supporting infrastructure and auxiliary systems). In some embodiments, during such time, liquefaction 108 may continue to operate at minimum rates (e.g., operation setpoint for prior nighttime operations). In other embodiments, liquefaction 108 may operate at rates higher than the minimum rates (e.g., operation setpoint for prior nighttime operations). For any given day of the year, the length of the night for a given facility location may be known as predicted, for example, by the National Oceanic and Atmospheric Administration (NOAA). FIG. 3 shows the length of nights for an exemplary facility 300. At such a facility, on the 90^{th} day of the year, there may be 11.45 hours between sunset and sunrise. Thus, the time during which the power storage of the power controller 104 is needed to provide the required nighttime power 120 and the stored gaseous hydrogen in gaseous hydrogen storage 112 is needed to supply gaseous hydrogen to liquefaction 108 for overnight operation to continue uninterrupted may also be known and used in the facility power balancing. Facility power balancing performed by power controller 104 may also consider the number of operating liquefaction trains in liquefaction 108 and the power requirements of the balance of facilities 116. Based on this information, facility power balancing performed by power controller 104 can determine the daytime power supplied 118 that is available for hydrogen production.

In certain embodiments, once sufficient daytime power supplied 118 is directed to the power storage of the power controller 104, storage of gaseous hydrogen in gaseous hydrogen storage 112, and/or the balance of facilities 116, facility power balancing performed by power controller 104 directs the remaining available power to maximize additional hydrogen production via electrolysis 106 and/or liquefaction 108 based on the amount of available power. In certain embodiments, the power storage of the power controller 104 may be fully charged and/or the gaseous hydrogen storage 112 may be filled to the maximum allowable level during the daytime (e.g., while power is supplied directly from the renewable source) before remaining daytime power is directed to additional hydrogen production via electrolysis 106 and/or liquefaction 108. In such embodiments, the operating facilities may be ramped up from existing setpoints to use excess or unexpected power from the renewable source. In some embodiments, liquefaction 108 may not be ramped up from nighttime operations until after the power storage of the power controller 104 is fully charged and/or the gaseous hydrogen storage 112 is filled to the maximum allowable levels. In other embodiments, the power storage of the power controller 104 and/or the gaseous hydrogen storage 112 may be filled to threshold (e.g., 50%, 60%, 70%, 80%, etc.) before at least a portion of the daytime power is directed to additional hydrogen production via electrolysis 106 and/or liquefaction 108. In such embodiments, the power storage of the power controller 104 and/or the gaseous hydrogen storage 112 may continue to be charged/filled until the maximum allowable levels during the daytime are reached. In other embodiments, the power storage of the power controller 104 and/or the gaseous hydrogen storage 112 may be charged/filled at pre-set rates throughout the daytime that are sufficient to ensure the maximum allowable levels during the daytime are reached before nighttime. In such embodiments, any excess power beyond the pre-set rates may be directed to additional hydrogen production via electrolysis 106 and/or liquefaction 108. In such embodiments, the pre-set rates may be based upon weather information (e.g., existing or forecasted). In such embodiments, liquefaction 108 may operate at a constant operation (e.g., flowrate) setpoint during the daytime, and the rate for electrolysis 106 may be reduced once the gaseous hydrogen storage 112 has reached the maximum allowable level. In certain embodiments, any excess power beyond what may be used by production system 100 may be curtailed.

FIG. 2 illustrates a green hydrogen production process (GHPP) 200 in accordance with certain embodiments. In certain embodiments, the green hydrogen production process (GHPP) 200 may be designed to operate continuously and vary hydrogen production based on the yearly, seasonal, and/or daily power production profiles, which may be based on historical data. In some embodiments, the renewable power source may be solar, and the power production profiles may be referred to as solar irradiance profiles. As shown in FIG. 2, the green hydrogen production process (GHPP) 200 may generally comprise power generation 202, facility power balancing 204, gaseous hydrogen production 206, hydrogen liquefaction 208, liquid hydrogen storage 210 and sale, gaseous hydrogen storage 212 and sale, and gaseous hydrogen compression 214 and sale.

The green hydrogen production process 200 may begin with power generation 202, which may include intermittent renewable power input 102 from FIG. 1. In certain embodiments, the intermittent renewable power input 102 may be generated via solar or PV arrays during daylight hours. In certain embodiments, such as when solar power is used as a renewable source for power generation 202, facility operations may be distinctly split into daytime operations and nighttime operations. In certain embodiments, an exemplary PV solar array may generate about 200 MW to about 1000 MW of direct current (DC) power over a period of about 6 to about 16 hours. In other embodiments, an exemplary PV solar array may generate about 300 MW to about 800 MW of DC power over a period of about 7 to about 13 hours. In some embodiments, an exemplary PV solar array may generate about 400 MW to about 700 MW of DC power over a period of about 8 to about 12 hours. In one embodiment, an exemplary PV solar array may generate 694 MW of DC power over about 8 hours. As will be appreciated by one skilled in the art, the generation by the PV solar array will depend upon, for example, seasonal variance in solar irradiation.

The power that is generated may undergo facility power balancing 204. As discussed above with respect to FIG. 1, facility power balancing 204 may be performed by power controller 104, and the power may first be directed to the power storage of the power controller 104, electrolysis 106, compression 110, and gaseous hydrogen storage 112. With reference to FIG. 2, the power likewise may first be directed to facility power balancing 204, including the power storage, gaseous hydrogen production 206, and gaseous hydrogen storage 212. This may allow power generated during the day to support nighttime operations. Given predictive data for weather and day/night durations, the time that will be needed to utilize the power storage (e.g., batteries) of power controller 104 for nighttime operations as well as the quantity of gaseous hydrogen storage 112 needed for nighttime operations may be known. In certain embodiments, the power storage may be able to support about 250 MWh to about 425 MWh usage, may be charged over a period of about 6 hours to about 12 hours, and may be discharged over the course of about 6 hours to about 18 hours as directed by the power controller 104. In other embodiments, the power storage may be able to support about 300 MWh to about 375 MWh usage, may be charged over a period of about 7 hours to about 11 hours, and may be discharged over the course of about 8 hours to about 16 hours as directed by the power controller 104. In some embodiments, the power storage may be able to support about 330 MWh to about 345 MWh usage, may be charged over a period of about 8 hours to about 10 hours, and may be discharged over the course of about 9 hours to about 14 hours as directed by the power controller 104. In one embodiment, the power storage may be able to support 330 MWh usage, may be charged over 8 hours, and may be discharged over the course of 16 hours as directed by the power controller 104. As will be appreciated by one skilled in the art, the charge and discharge times will depend upon, for example, seasonal variance in solar irradiation.

As discussed above with respect to FIG. 1, once the power storage of the power controller 104 and the gaseous hydrogen storage 112 capacities needed are fulfilled (e.g., at maximum level or at a lower threshold level), the intermittent renewable power input 102 may then be directed by the power controller 104 to equipment and processes supporting hydrogen production, including gaseous hydrogen production 206 using electrolysis 106 and hydrogen liquefaction 208 using liquefaction 108. In certain embodiments, about 1.75 km³/day to about 3.15 km³/day of water may be available for processing by electrolyzers in gaseous hydrogen production 206, which may use about 250 MW to about 450 MW to generate about 115 tons per day (TPD) to about 250 TPD of gaseous hydrogen. In other embodiments, 1.9 km³/day to about 3.0 km³/day of water may be available for processing by electrolyzers in gaseous hydrogen production 206, which may use about 275 MW to about 425 MW to generate about 125 TPD to about 225 TPD of gaseous hydrogen. In some embodiments, about 2.1 km³/day to about 2.8 km³/day of water may be available for processing by electrolyzers in gaseous hydrogen production 206, which may use about 300 MW to about 400 MW to generate about 150 TPD to about 195 TPD of gaseous hydrogen. In certain embodiments, the water that is available for processing by the electrolyzers may be freshwater, wastewater, or seawater. As discussed above with respect to FIG. 1, once gaseous hydrogen production 206 using electrolysis 106 is complete, the produced gaseous hydrogen may undergo compression 110 and may be sent to gaseous hydrogen storage 112, one or more liquefaction trains in liquefaction 108, or offtake (e.g., via trailers, trucks, etc.) (not depicted). As shown in FIG. 2, the gaseous hydrogen may undergo further compression before being stored in gaseous hydrogen storage 112 or directed to offtake.

After hydrogen production 206, the hydrogen liquefaction 208 may begin. With a known charge state of the power storage of power controller 104 and known quantity of gaseous hydrogen in gaseous hydrogen storage 112, as well as a known number of liquefaction 108 trains in use, a facility may calculate an appropriate hydrogen liquefaction 208 rate or “turndown” for both daytime and nighttime operations. The purpose is to ensure that there will be adequate power to maintain operations through the night, thus avoiding a liquefaction turndown trip and minimizing liquification recycling operations.

In certain embodiments, maximum combined liquefaction rates for all operational trains in hydrogen liquefaction 208 at peak operation may be about 4800 kg/h or below. In other embodiments, maximum combined liquefaction rates for all operational trains in hydrogen liquefaction 208 at peak operation may be about 4000 kg/h or below. In some embodiments, maximum combined liquefaction rates for all operational trains in hydrogen liquefaction 208 at peak operation may be about 3750 kg/h or below. In certain embodiments, the minimum combined operation setpoint for all operational trains in hydrogen liquefaction 208 at turndown (e.g., during nighttime operations) may be about 500 kg/h or above. In other embodiments, the minimum combined operation setpoint for all operational trains in hydrogen liquefaction 208 at turndown (e.g., during nighttime operations) may be about 1000 kg/h or above. In some embodiments, the minimum combined operation setpoint for all operational trains in hydrogen liquefaction 208 at turndown (e.g., during nighttime operations) may be about 1500 kg/h or above. In certain embodiments, hydrogen liquefaction 208 may be performed by up to three 30 TPD liquefaction units (or trains). As will be appreciated by one skilled in the art, the total number of trains in hydrogen liquefaction 208 may vary depending on, for example, train size and upstream gaseous hydrogen generating capacity. In certain embodiments, the selection of the number of operational liquefaction trains on any given day may be initially set based on power (e.g., solar) production profile. In certain embodiments, a daily solar irradiance (or production) profile may be generated based on solar power to one or more PV arrays (e.g., in a solar farm) and may further be based on geographical location, PV array characteristics, and additional systems losses, including losses attributable to cables, transformers and PV fouling, weather, and other expected loss factors that occur before the power controller 104. In certain embodiments, the power (e.g., solar) production profile may be used to set an initial number of operating liquefaction trains as well as initial estimates for the timing of and setpoints for the day/night operating transition. However, as described above with respect to FIG. 1 and further discussed below, the actual process control systems that set the operating parameters (e.g., setpoints) across the production system 100 may be done based on the actual measured solar irradiance and the process operation for any given day, along with the power storage and the gaseous hydrogen storage achieved based on daytime power supplied 118.

The electrolysis 106 capacity may be intentionally designed to be greater than that of the liquefaction 108 system so that the production facility 100 may utilize nighttime hours to continuously run the liquefaction trains in liquefaction 108. As discussed above with respect to FIG. 1, the liquefaction controller 114 may select whether to send gaseous hydrogen from electrolysis 106 to gaseous hydrogen storage 112 or to liquefaction 108 during the day so that liquefaction 108 operations may continue throughout the night. In making this selection, gaseous hydrogen storage is prioritized, and excess power above the amount of power required to fill the gaseous storage is supplied to power the liquefaction process. In certain embodiments, the full amount of the predicted solar irradiance on any given day may not be met (e.g., unexpected weather). When this occurs, the daytime and/or nighttime operation of the selected number of operating liquefaction trains may need to be reduced (or turned down) or possibly shutdown entirely temporarily until solar power is restored to expected levels.

Based on the predicted length of the night (the time between sunset and sunrise) according to historical weather data, the length of time that the power storage (e.g., batteries) of the power controller 104 is required to supply power to the process can be determined by the power controller 104. In certain embodiments, the power controller 104 may direct whether power is supplied to the process equipment (e.g., liquefaction 108, electrolysis 106) from the intermittent renewable power input 102 or from stored energy from the power storage (e.g., batteries) of the power controller 104 based at least in part on the predicted length of night. At the end of each day, the charge state of the power storage (e.g., batteries) of the power controller 104, the amount of gaseous hydrogen in the gaseous hydrogen storage 112, and the number of operating liquefaction trains is known. Based on this information, the turndown setpoint of the operating liquefaction trains, electrolyzers, and associated auxiliary equipment can be properly calculated by the power controller 104 so that operations can continue through the night without depleting the power storage (e.g., batteries) of the power controller 104. In some embodiments, the turndown setpoint (e.g., flowrate) for electrolysis 106 may cause the electrolyzers to shut down overnight, and liquefaction 108 may be supplied solely with gaseous hydrogen from gaseous hydrogen storage 112. In other embodiments, the turndown setpoint (e.g., flowrate) for electrolysis 106 may reduce the rate at which gaseous hydrogen is produced overnight, and liquefaction 108 may be supplied with gaseous hydrogen from both electrolysis 106 and gaseous hydrogen storage 112. In certain embodiments, a turndown setpoint (e.g., flowrate) may be determined based on each of the charge state of the power storage (e.g., batteries) of the power controller 104 and the amount of gaseous hydrogen in the gaseous hydrogen storage 112, and the power controller 104 may select the lowest turndown setpoint (e.g., flowrate). In certain embodiments, if the determined turndown setpoint (e.g., flowrate) is below the minimum operating capacity for a liquefaction train, one or more liquefaction trains may be such down or tripped to increase the turndown rate for the remaining operating liquefaction trains.

In certain embodiments, the green hydrogen production process 200 may end with the liquid hydrogen storage and sale 210 phase, the gaseous hydrogen storage 212 and sale phase, and/or the gaseous hydrogen compression 214 and sale phase. Once liquefaction 108 and compression 110 activities are complete, the liquid hydrogen may be placed in liquid storage vessels until it is sold and distributed. In certain embodiments, two or three 100 MT spherical tanks and two 30 MT blimp tanks may be used to store liquid hydrogen. As will be appreciated by one skilled in the art, the total number of liquid hydrogen storage tanks may vary depending on, for example, the reliability of the system, system capacity, and offtake requirements and/or demands. In certain embodiments, the liquid hydrogen storage may support a truck tank loadout of about 45 TPD to about 55 TPD over about 6 to about 9 hours. In certain embodiments, maximum gaseous storage available may be about 20 metric tons to about 60 metric tons. In other embodiments, maximum gaseous storage available may be about 25 metric tons to about 50 metric tons. In some embodiments, maximum gaseous storage available may be about 25 metric tons to about 40 metric tons. In one embodiment, maximum gaseous storage available may be about 30 metric tons. As will be appreciated by one skilled in the art, the maximum gaseous storage available may be less than the total capacity of the gaseous hydrogen storage 112 due to the ability to dispatch or remove gaseous hydrogen from storage based at least in part on storage pressure. In one embodiment, the gaseous hydrogen may be stored in underground or subterranean vessels. As used herein, the terms “vessel” and “tank” are not limiting and may refer to any container, receptacle, or chamber for holding, storing, and/or transporting a gas or liquid as applicable. A new day may then restart the green hydrogen production process 200 with power generation 202, with some seasonal caveats.

During summer operation, the days are longer (13-14.5 hours) and solar irradiance reaches its peak. Thus, nighttime operations may be shortened, and hydrogen and battery storage may be maximized, in turn maximizing overall hydrogen production. In the spring, fall, and winter seasons, the days are shorter and solar irradiance is reduced. This results in lower hydrogen production as compared to the summer months.

Given these seasonal variations, the set number of operating liquefaction trains may also need to vary seasonally within an operating window consistent with the best practices and procedures for the facility hydrogen production equipment, as will be appreciated by one skilled in the art. This may support optimized liquefaction and minimized loss of battery power. It may also help avoid emptying the hydrogen storage. With a 3×30 TPD liquefaction design, in certain embodiments, an ideal operating profile may be: (i) Summer: 3× train; (ii) Spring and Fall: 2× train; and (iii) Winter: 1× train. The seasonal transition dates, based on which the set number of operational liquefaction trains may vary, may be determined by a control algorithm of the power controller 104 based on the seasonal irradiance profile for the facility's geographical location.

Optimal control is based on maximizing hydrogen production while minimizing liquefaction operation variability. The ideal seasonal solar irradiance profile includes daily daytime and nighttime durations (sunrise and sunset) to be used to set the liquefaction production rate in the nighttime power controller. Given a known ideal solar irradiance profile, the power controller 104 determines production rates and liquefaction operations for 3, 2, and 1 train production. As will be appreciated by one skilled in the art, this is done through an operating window consistent with the best practices and procedures for the facility hydrogen production equipment. For a given solar irradiance profile, a fixed operating train profile (e.g., number of operating liquefaction trains) will be generated, and this forms the basis for the process operating configuration for daily process operation. However, as discussed above, the solar irradiance that arrives on a given day may not match the historical solar irradiance profile, and in certain embodiments, it may be necessary to turndown one or more liquefaction trains. In certain embodiments, if the calculated turndown level falls within two to three trains operating, three trains will be selected. Similarly, if the calculated turndown level falls within one to two trains operating, two trains will be selected. Otherwise, one train will be selected. If there is insufficient power from the solar irradiance that arrives on a given day, one or more liquefaction trains may be tripped or shut down. This allows the system to continue operation in island mode as designed. In such embodiments, trains may be brought back into service when sufficient power is achieved, for example, based on adequate charge state of the power storage (e.g., batteries) of the power controller 104, adequate daytime power supply 118, forecasted solar irradiance profiles, and/or the like. Based on liquefaction train operability metrics, including ramp-up times and maximum tolerable recycle operations or train trips, the optimal number of liquefaction trains to maximize hydrogen production given the available power is selected.

In certain embodiments, the control algorithm of the power controller 104 also has the ability to include a forecasted solar irradiance profile. For example, if a weather system is incoming, the ideal solar irradiance profile-based control may be overly optimistic. Including the forecast information in the control algorithm of the power controller 104 enables the power controller 104 to appropriately select the liquefaction train operations and set the daily production profile. This may help to avoid gaseous hydrogen and battery storage losses and improve the process reliability. In certain embodiments, the use of a forecasted solar irradiance profile may allow tripped trains to be brought back online more reliably and, in some embodiments, may allow the production system to get back to full or maximized hydrogen production more quickly. For example, the use of a forecasted solar irradiance profile may indicate that a delayed train restart is appropriate when the forecast does not support an additional liquefaction train. In certain embodiments, a forecasted solar irradiance profile may be used to override the predetermined train profile based on, for example, a historical solar irradiance profile, and bring on additional liquefaction trains in times of unexpected high solar levels. In certain embodiments, the use of a forecasted solar irradiance profile may be particularly useful around the transition points in the train operating profile, that is, around the transition from one to two trains or from two to three trains. Because these transition points are estimates, the actual solar irradiance that occurs around these transition points may allow the transition to occur sooner than specified based on forecast data or may allow the transition to occur over a known short duration as determined by the forecast data.

In certain embodiments, the weather and power predictions and the operational decisions described above may be achieved by having a validated digital twin of the system and process. As will be appreciated by one skilled in the art, the digital twin may be used to determine the best overall operating strategy for the forecast information, including train operation and turndown. This relates both to turning down and/or shutting down trains and to bringing on previously shutdown or tripped trains.

The GHPP may support the following as a digital operating twin: (i) facility sizing and optimization in the pre-construction, front-end engineering design (FEED) stage of a project; (ii) facility design verification and pre-commissioning during the construction phase; and (iii) operations advisory and/or real-time optimization.

As with most complex systems, the power controller 104 will take continuous measurements and/or continuously record system data (e.g., power in from sensors, power consumed, turndown setpoints). These measurements and data will create a database of yearly, seasonal, monthly, daily, and hourly operational data that can be used to provide model based predictive control that may be implemented in power controller 104 and aid the operation of the validated digital twin. This can ultimately be used to improve and update the control algorithm of the power controller 104 on a continuous basis.

The process flowchart of FIG. 2 shows the main elements of the process at an illustrative facility scale. The low/zero carbon intensity (green) hydrogen production process enables the optimization of facility design such that facility configuration and component sizing can be assessed and optimized for target production metrics. This includes the: (i) sizing of electrical and hydrogen storage and their impact on facility responses and overall performance; (ii) assessment of facility resilience against variable renewables and external drivers such as weather, water supply, and offtake; (iii) refining of operational controls to ensure desired facility performance and behavior; and (iv) assessment of technoeconomic metrics that factor in dynamic facility behavior.

TABLE 1
Main GHPP Elements and their Metrics

| Process Item | Metrics to Manage |
|---|---|
| Renewable Energy | Capacity, hourly energy production |
| Production | |
| Battery Energy Storage | Capacity, round-trip efficiency, charging/ |
| | discharge rates, minimum charge levels |
| Electrolyzer | Number of units, productivity, temperature, |
| | conversion efficiency |
| Liquefaction | Capacity, efficiency, idle consumption |
| Compression | Capacity, efficiency, idle consumption |
| Hydrogen Storage | Capacity, charging/discharging rates, |
| (Gaseous and Liquid) | minimum charge levels |

FIG. 3 illustrates a length of nights for an exemplary facility 300 in accordance with one embodiment. For each day of the year from a zero point at midnight of the first day of the year through the cycle of 365 days, a number of hours for which the exemplary facility experiences nighttime solar levels for that day is shown. For example, at the winter solstice (day 354 in the northern hemisphere) the nighttime hours reach a maximum 302 of 14.25 hours for this facility. At the summer solstice (day 171 in the northern hemisphere), nighttime hours reach a minimum 304 of 9.5 hours. For each day, the length of nights for an exemplary facility 300 may indicate the time the facility may expect to operate without solar power, provided the weather is clear. Additional climactic adjustments may be forecast on a day-to-day basis.

FIG. 4 illustrates a summer daytime power utilization profile for an exemplary facility 400 in accordance with one embodiment. In one embodiment, the exemplary facility may produce 20 kilotonnes per annum (KTPA) of hydrogen. The profile shows five different power curves, measured in megawatts (MW) of power, used at each of the 24 hours of a one-day period. The five curves shown are for supplied intermittent renewable power 402, total power needed 404, electrolyzer power 406, balance of facility power 408, and battery energy storage system charge power 410.

The supplied intermittent renewable power 402 may be supplied by a solar grid, and thus may fluctuate from at or near zero during nighttime hours to a maximum of around 525 MW during daylight operation. The balance of facility power 408 is used to supply all power to the process for systems other than the battery charging, which uses battery energy storage system charge power 410, and hydrogen production via electrolysis, which uses electrolyzer power 406. FIG. 4 shows the power profiles for each system which track the incoming supplied intermittent renewable power 402. Once the supplied intermittent renewable power 402 reaches the solar installed capacity, the system may produce at a maximum liquefaction rate, and the difference between the liquefaction production and the total hydrogen production is sent to battery energy storage system charge power 410. For a given day, when the battery and hydrogen storage are fully charged before sunset, as shown, the power controller may divert excess power to hydrogen production if possible. Otherwise, the power may be curtailed at the inlet. A well-designed system may operate such that the total power needed 404 aligns with the supplied intermittent renewable power 402 as shown and may minimize the need for input power curtailment.

In FIG. 3, the length of nights for an exemplary facility 300 shows the variation in nighttime duration throughout the year, which is converse to the variation of daytime duration. The summer (June in the northern hemisphere) has a day length of around 14 hours compared to winter (January in the northern hemisphere) when it drops to around 9 hours. The variation in solar power during the day gives rise to a net variation in solar capacity. The solar capacity is the area under the supplied intermittent renewable power 402 curve shown in FIG. 4. The solar capacity (MWh) per day has a peak during summer and a minimum during the winter. The amount of variation in solar capacity limits the amount of hydrogen that can be produced in any given day.

If for a given day too many liquefaction trains are in operation, the amount of available energy stored in the battery or used to produce hydrogen for storage may be insufficient to allow the nighttime process to operate continuously. In this case, all stored hydrogen may be consumed, thus leading the liquefaction trains to trip or operate in a recycle mode, or the battery may be emptied, causing a site-wide loss of power. Conversely if too few liquefaction trains are in operation, production may be lost, and the number of operating trains may need to increase to capture that lost production. To avoid these suboptimal cases, the correct number of operating trains, based on the known liquefaction turndown limits, may be adjustably selected continuously throughout the year. This selection may be adjusted as the daytime length varies and may be performed with a five-day fixed operating window to support reliable and stable liquefaction operation between train number changes.

Based on the yearly solar power profile trend, from January to June an increasing operating train profile may be expected, and from June to December a decreasing profile may be expected. The criteria for allowable liquefaction train operation and the number of trips or number of recycle operating periods may be set by the liquefaction design. This design criteria may be the decision variable used to increase or decrease the number of operating trains. For a given installed solar capacity and process design, the ideal liquefaction train numbers may be calculated based on the NOAA annual solar irradiance profiles. In addition, the facility local weather variation based on a five day look ahead of forecasted weather data may be used to update the ideal predicted profiles and optimize liquefaction production and operation.

FIG. 5 illustrates an embodiment of a computational apparatus 500 to implement components and process steps of the system described herein.

Input devices 504 comprise transducers that convert physical phenomenon into machine internal signals, typically electrical, optical or magnetic signals. Signals may also be wireless in the form of electromagnetic radiation in the radio frequency (RF) range but also potentially in the infrared or optical range. Examples of input devices 504 are keyboards which respond to touch or physical pressure from an object or proximity of an object to a surface, mice which respond to motion through space or across a plane, microphones which convert vibrations in the medium (typically air) into device signals, scanners which convert optical patterns on two or three dimensional objects into device signals. The signals from the input devices 504 are provided via various machine signal conductors (e.g., busses or network interfaces) and circuits to memory 506.

The memory 506 is typically what is known as a first or second level memory device, providing for storage (via configuration of matter or states of matter) of signals received from the input devices 504, instructions and information for controlling operation of the processing unit 502, and signals from storage devices 510.

The memory 506 and/or the storage devices 510 may store computer-executable instructions and thus forming logic 514 that when applied to and executed by the processing unit 502 implement embodiments of the processes disclosed herein.

Information stored in the memory 506 is typically directly accessible to the processing unit 502 of the device. Signals input to the device cause the reconfiguration of the internal material/energy state of the memory 506, creating in essence a new machine configuration, influencing the behavior of the computational apparatus 500 by affecting the behavior of the processing unit 502 with control signals (instructions) and data provided in conjunction with the control signals.

Second or third level storage devices 510 may provide a slower but higher capacity machine memory capability. Examples of storage devices 510 are hard disks, optical disks, large capacity flash memories or other non-volatile memory technologies, and magnetic memories.

The processing unit 502 may cause the configuration of the memory 506 to be altered by signals in storage devices 510. In other words, the processing unit 502 may cause data and instructions to be read from storage devices 510 in the memory 506 from which may then influence the operations of processing unit 502 as instructions and data signals, and from which it may also be provided to the output devices 508. The processing unit 502 may alter the content of the memory 506 by signaling to a machine interface of memory 506 to alter the internal configuration, and then converted signals to the storage devices 510 to alter its material internal configuration. In other words, data and instructions may be backed up from memory 506, which is often volatile, to storage devices 510, which are often non-volatile.

Output devices 508 are transducers which convert signals received from the memory 506 into physical phenomenon such as vibrations in the air, or patterns of light on a machine display, or vibrations (i.e., haptic devices) or patterns of ink or other materials (i.e., printers and 3-D printers).

The network interface 512 receives signals from the memory 506 and converts them into electrical, optical, or wireless signals to other machines, typically via a machine network. The network interface 512 also receives signals from the machine network and converts them into electrical, optical, or wireless signals to the memory 506.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

Herein, references to “one embodiment,” “certain embodiments,” or “an embodiment” do not necessarily refer to the same embodiment, although they may. Unless the context clearly requires otherwise, throughout the description and the claims, the words “comprise,” “comprising,” “include,” “including,” and the like are to be construed in an inclusive sense as opposed to an exclusive or exhaustive sense; that is to say, in the sense of “including, but not limited to.” Words using the singular or plural number also include the plural or singular number respectively, unless expressly limited to a single one or multiple ones. Additionally, the words “herein,” “above,” “below” and words of similar import, when used in this application, refer to this application as a whole and not to any particular portions of this application. When the claims use the word “or” in reference to a list of two or more items, that word covers all of the following interpretations of the word: any of the items in the list, all of the items in the list and any combination of the items in the list, unless expressly limited to one or the other. Any terms not expressly defined herein have their conventional meaning as commonly understood by those having skill in the relevant art(s).

Various logic functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

As shown in FIG. 6, computer system/server 602 in a cloud computing node 600 is shown in the form of a general-purpose computing device. The components of computer system/server 602 may include, but are not limited to, one or more processors or processing units 606, a system memory 604, and a bus 626 that couples various system components including system memory 604 to processor processing units 606.

Bus 626 represents one or more of any of several types of bus structures, including a memory bus or memory controller, a peripheral bus, an accelerated graphics port, and a processor or local bus using any of a variety of bus architectures. By way of example, and not limitation, such architectures include Inter-Integrated Circuit (I2C), Serial Peripheral Interface (SPI), Controller Area Network (CAN), Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 602 typically includes a variety of computer system readable media. Such media may be any available media that is accessible by computer system/server 602, and it includes both volatile and non-volatile media, removable and non-removable media.

System memory 604 may include computer system readable media in the form of volatile memory, such as Random access memory (RAM) 608 and/or cache memory 612. Computer system/server 602 may further include other removable/non-removable, volatile/non-volatile computer system storage media. By way of example only, a storage system 620 may be provided for reading from and writing to a non-removable, non-volatile magnetic media (not shown and typically called a “hard drive”). Although not shown, a flash drive, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media may be provided. In such instances, each may be connected to bus 626 by one or more data media interfaces. As will be further depicted and described below, system memory 604 may include at least one program product having a set (e.g., at least one) of program modules that are configured to carry out the functions of the invention.

Program/utility 622 having a set (at least one) of program modules 624 may be stored in system memory 604 by way of example, and not limitation, as well as an operating system, one or more application programs, other program modules, and program data. Each of the operating system, one or more application programs, other program modules, and program data or some combination thereof, may include an implementation of a networking environment. Program modules 624 generally carry out the functions and/or methodologies of the invention as described herein.

Computer system/server 602 may also communicate with one or more external devices 614 such as a keyboard, a pointing device, a display 616, etc.; one or more devices that enable a user to interact with computer system/server 602; and/or any devices (e.g., network card, modem, etc.) that enable computer system/server 602 to communicate with one or more other computing devices. Such communication may occur via I/O interfaces 610. I/O interfaces 610 may also manage input from sensors and peripheral connected wirelessly or through wired connection with the computer system/server 602, as well as output to actuators and peripherals also so connected.

Still yet, computer system/server 602 may communicate with one or more networks such as a local area network (LAN), a general wide area network (WAN), and/or a public network (e.g., the Internet) via network adapter 618. As depicted, network adapter 618 communicates with the other components of computer system/server 602 via bus 626.

It will be understood that although not shown, other hardware and/or software components may be used in conjunction with computer system/server 602. Examples include, but are not limited to: microcode, device drivers, redundant processing units, external disk drive arrays, RAID systems, tape drives, and data archival storage systems, etc.

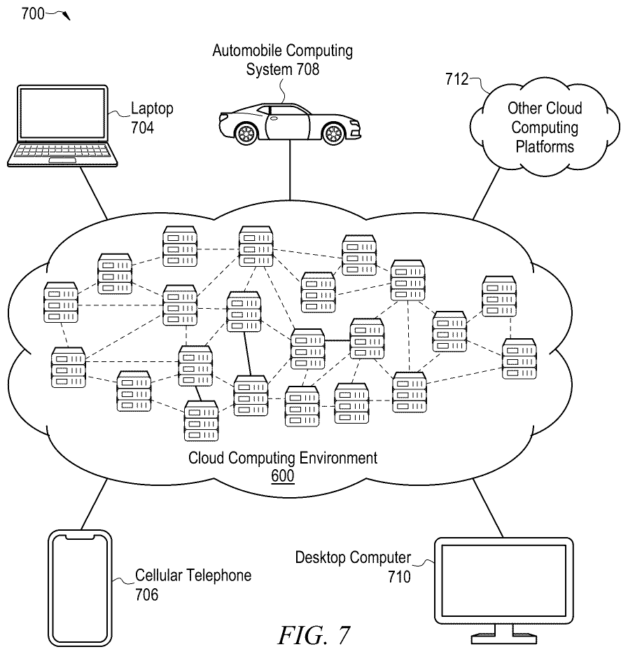

Referring now to FIG. 7, an illustrative cloud computing environment 702 is depicted in a cloud computing system 700. “Cloud computing” in this disclosure refers to a model for enabling convenient, on-demand network access to a shared pool of configurable computing resources (e.g., networks, servers, storage, applications, and services) that can be rapidly provisioned and released with minimal management effort or service provider interaction. This cloud model promotes availability and is comprised of at least five characteristics, at least three service models, and at least four deployment models. Examples of commercially hosted cloud computing systems 700 include Amazon Web Services (AWS), Google Cloud, Microsoft Azure, etc.

As shown, cloud computing environment 702 comprises one or more cloud computing nodes 600 with which computing devices such as, for example, laptops 704, personal digital assistants (PDAs) or cellular telephones 706, automobile computer systems 708, desktop computers 710, and other cloud computing platforms 712, may communicate.

This allows for infrastructure, platforms, and/or software to be offered as services from cloud computing environment 702, so as to not require each client to separately maintain such resources. It is understood that the types of computing devices shown in FIG. 7 are intended to be illustrative only and that cloud computing environment 702 may communicate with any type of computerized device over any type of network and/or network/addressable connection (e.g., using a web browser).

Cloud computing is a model of service delivery for enabling convenient, on-demand network access to a shared pool of configurable computing resources (e.g., networks, network bandwidth, servers, processing, memory, storage, applications, virtual machines, and services) that may be rapidly provisioned and released with minimal management effort or interaction with a provider of the service. This cloud model may include at least five characteristics, at least three service models, and at least four deployment models.

### Characteristics are as Follows:

“On-demand self-service” in this disclosure refers to a consumer can unilaterally provision computing capabilities, such as server time and network storage, as needed, automatically without requiring human interaction with each service's provider.
“Broad network access” in this disclosure refers to capabilities that are available over a network and accessed through standard mechanisms that promote use by heterogeneous thin or thick client platforms (e.g., mobile phones, laptops, and PDAs).
“Resource pooling” in this disclosure refers to the provider's computing resources are pooled to serve multiple consumers using a multi-tenant model, with different physical and virtual resources dynamically assigned and reassigned according to consumer demand. There is a sense of location independence in that the customer generally has no control or knowledge over the exact location of the provided resources but may be able to specify location at a higher level of abstraction (e.g., country, state, or datacenter). Examples of resources include storage, processing, memory, network bandwidth, and virtual machines.
“Rapid elasticity” in this disclosure refers to capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
“Measured service” in this disclosure refers to cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

### Service Models are as Follows:

“Cloud Software as a Service (Saas)” in this disclosure refers to the capability provided to the consumer is to use the provider's applications running on a Cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.
“Cloud Platform as a Service (PaaS)” in this disclosure refers to the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.
“Cloud Infrastructure as a Service (IaaS)” in this disclosure refers to the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

“Private cloud” in this disclosure refers to the cloud infrastructure is operated solely for an organization. It may be managed by the organization or a third party and may exist on-premises or off-premises.
“Community cloud” in this disclosure refers to the cloud infrastructure is shared by several organizations and supports a specific community that has shared concerns (e.g., mission, security requirements, policy, and compliance considerations). It may be managed by the organizations or a third party and may exist on-premises or off-premises.
“Public cloud” in this disclosure refers to the cloud infrastructure is made available to the general public or a large industry group and is owned by an organization selling cloud services.
“Hybrid cloud” in this disclosure refers to the cloud infrastructure is a composition of two or more clouds (private, community, or public) that remain unique entities but are bound together by standardized or proprietary technology that enables data and application portability (e.g., cloud bursting for load-balancing between Clouds).

A cloud computing environment 702 may be service oriented with a focus on statelessness, low coupling, modularity, and semantic interoperability. At the heart of cloud computing is an infrastructure that includes a network of interconnected nodes. It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

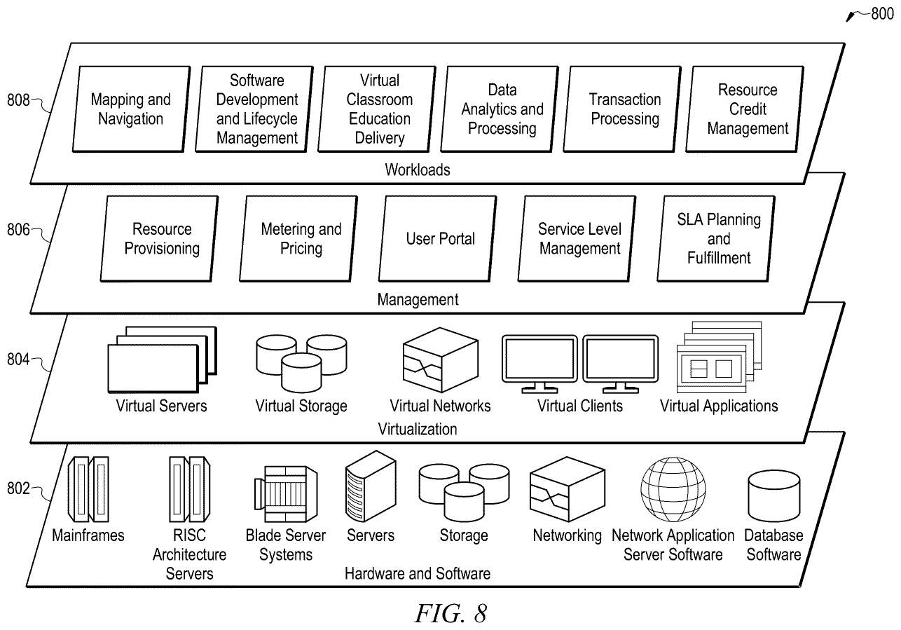

Referring now to FIG. 8, a set of functional abstraction layers provided by cloud computing systems 700 such as those illustrated in FIG. 7 is shown. It should be understood in advance that the components, layers, and functions shown in FIG. 8 are intended to be illustrative only, and the invention is not limited thereto. As depicted, the following layers and corresponding functions are provided:

Hardware and software layer 802 includes hardware and software components. Examples of hardware components include mainframes, reduced instruction set computer (RISC) architecture-based servers, servers, blade servers, storage devices, and networks and networking components. Examples of software components include network application server software and database software.

Virtualization layer 804 provides an abstraction layer from which the following exemplary virtual entities may be provided: virtual servers; virtual storage; virtual networks, including virtual private networks; virtual applications; and virtual clients.

Management layer 806 provides the exemplary functions described below. Resource provisioning provides dynamic procurement of computing resources and other resources that are utilized to perform tasks within the Cloud computing environment. Metering and Pricing provide cost tracking as resources are utilized within the cloud computing environment, and billing or invoicing for consumption of these resources. In one example, these resources may comprise application software licenses. Security provides identity verification for users and tasks, as well as protection for data and other resources. User portal provides access to the cloud computing environment for both users and system administrators. Service level management provides cloud computing resource allocation and management such that required service levels are met. Service Level Agreement (SLA) planning and fulfillment provides pre-arrangement for, and procurement of, cloud computing resources for which a future requirement is anticipated in accordance with an SLA.

Workloads layer 808 provides functionality for which the cloud computing environment is utilized. Examples of workloads and functions which may be provided from this layer include: mapping and navigation; software development and lifecycle management; virtual classroom education delivery; data analytics processing; transaction processing; and resource credit management. As mentioned above, all of the foregoing examples described with respect to FIG. 8 are illustrative only, and the invention is not limited to these examples.

What is claimed is:

1. A system comprising:
an intermittent renewable power input that is supplied power from an intermittent renewable energy source for a first time period;
a power controller coupled to the intermittent renewable power input,
wherein the power controller comprises a power storage, and
wherein at least a portion of the power supplied to the intermittent renewable power input is supplied to the power storage during the first time period;
one or more electrolyzers coupled to the intermittent renewable power input and the power storage,
wherein the one or more electrolyzers are configured to split water molecules into gaseous hydrogen and oxygen, and
wherein at least a portion of the power supplied to the intermittent renewable power input is supplied to the one or more electrolyzers during the first time period;
one or more liquefaction trains coupled to the intermittent renewable power input, the power storage, and the one or more electrolyzers,
wherein the one or more liquefaction trains are configured to convert at least a portion of the gaseous hydrogen from the one or more electrolyzers into liquid hydrogen, and
wherein at least a portion of the power supplied to the intermittent renewable power input is supplied to the one or more liquefaction trains during the first time period, and
wherein at least a portion of the power supplied to the power storage during the first time period is supplied to the one or more liquefaction trains during a second time period;
one or more gaseous hydrogen storage tanks coupled to the one or more electrolyzers and the one or more liquefaction trains, wherein the one or more gaseous hydrogen storage tanks are configured to receive at least a portion of the gaseous hydrogen from the one or more electrolyzers during at least the first time period and supply at least a portion of the gaseous hydrogen to the one or more liquefaction trains during at least the second time period; and
a liquefaction controller coupled to the power controller and at least one of the one or more liquefaction trains,
wherein the power controller determines a first turndown setpoint for at least one of the one or more liquefaction trains based at least in part on one or more of a known state of charge of the power storage, a known state of charge of the one or more of the gaseous hydrogen storage tanks, a quantity of the one or more liquefaction trains in operation, and a predicted length of the second time period; and
wherein the liquefaction controller receives the first turndown setpoint from the power controller and determines one or more operating setpoints for the at least one of the one or more liquefaction trains based at least in part on at least the first turndown setpoint.

2. The system of claim 1 further comprising one or more compressors coupled to the intermittent renewable power input, the power storage, and the one or more electrolyzers, wherein the one or more compressors are configured to compress gaseous hydrogen from the electrolyzers.

3. The system of claim 1 further comprising: an electrolysis controller coupled to the power controller and at least one of the one or more electrolyzers,
wherein the power controller determines a second turndown setpoint for at least one of the one or more electrolyzers based at least in part on one or more of the state of charge of the power storage, the known state of charge of the one or more of the gaseous hydrogen storage tanks, the quantity of the one or more liquefaction trains in operation, and the predicted length of the second time period, and
wherein the electrolysis controller receives the second turndown setpoint from the power controller and determines one or more operating setpoints for the at least one of the one or more electrolyzers based at least in part on the second turndown setpoint.

4. The system of claim 1, wherein the power storage comprises a battery selected from the group consisting of a flow battery, a solid-state battery, a thermal energy storage batter, and any combination thereof.

5. The system of claim 1 further comprising: one or more liquid hydrogen storage tanks coupled to the one or more liquefaction trains.

6. The system of claim 1, wherein the first time period and the second time period are a 24-hour day when combined.

7. A method comprising:
receiving into a hydrogen production system power from an intermittent renewable energy source during a first time period;
transferring at least a first portion of the power from the intermittent renewable energy source to a power storage of a power controller during the first time period until a threshold charge of the power storage is reached;
transferring at least a second portion of the power from the intermittent renewable energy source to at least one electrolyzer during the first time period, wherein the at least one electrolyzer uses the second portion of the intermittent renewable power to produce gaseous hydrogen;
transferring at least a first portion of the gaseous hydrogen produced by the at least one electrolyzer to at least one gaseous hydrogen storage tank during the first time period until a threshold charge of the at least one gaseous hydrogen storage tank is reached; and
transferring at least a second portion of the gaseous hydrogen produced by the one or more electrolyzers to at least one liquefaction train during the first time period, wherein the at least one liquefaction train converts the second portion of the gaseous hydrogen to liquid hydrogen at a flowrate setpoint.

8. The method of claim 7, wherein the flowrate setpoint of the at least one liquefaction train remains constant during the first time period, and wherein the first portion of the gaseous hydrogen produced by the at least one electrolyzer is transferred to the at least one gaseous hydrogen storage tank during the first time period at a pre-set flowrate such that the threshold charge of the at least one gaseous hydrogen storage tank is reached before a second time period.

9. The method of claim 8, wherein the second time period is a duration of time in which power from the intermittent renewable energy source is unavailable.

10. The method of claim 7 further comprising:
increasing the flowrate setpoint of the at least one liquefaction train after at least one of the threshold charge of the power storage and the threshold charge of the at least one gaseous hydrogen storage tank is reached.

11. The method of claim 7 further comprising:
transferring at least a portion of the gaseous hydrogen from the at least one gaseous hydrogen storage tank to the at least one liquefaction train during a second time period;
transferring at least a portion of the first portion of the power from the intermittent renewable energy source from the power storage to the at least one liquefaction train during the second time period;
setting the flowrate setpoint of the at least one liquefaction train during the second period based at least in part on one or more of a known state of charge of the power storage, a known state of charge of the at least one gaseous hydrogen storage tank, a quantity of liquefaction trains in the hydrogen production system that are in operation, and a predicted length of the second time period.

12. The method of claim 11, wherein the first time period and the second time period are a 24-hour day when combined.

13. The method of claim 11, wherein the intermittent renewable power source comprises solar power, and wherein the first time period comprises daytime and the second time period comprises nighttime.

14. The method of claim 7 further comprising:
operating the at least one liquefaction train at a second flowrate setpoint during a second time period, wherein the second flowrate setpoint is determined based at least in part on one or more of a known state of charge of the power storage, a known state of charge of the at least one gaseous hydrogen storage tank, a quantity of liquefaction trains in the hydrogen production system that are in operation, and a predicted length of the second time period.

15. The method of claim 14, wherein the second time period is a duration of time in which power from an intermittent renewable energy source is unavailable.

16. A method comprising:
generating a predicted solar irradiance profile using historical solar irradiance data for a geographical location of a hydrogen production system, wherein the hydrogen production system comprises a plurality of liquefaction trains;
generating a fixed operating liquefaction train profile based at least in part on the predicted solar irradiance profile, wherein the fixed operating train profile comprises a quantity of operating liquefaction trains within the plurality of liquefaction trains;
determining a real-time or forecasted amount of solar irradiance at the geographical location of the hydrogen production system; and
adjusting the fixed operating train profile based at least in part on a difference between the predicted solar irradiance profile and the real-time or forecasted amount of solar irradiance at the geographical location of the hydrogen production system.

17. The method of claim 16, wherein the predicted solar irradiance profile exceeds the real-time or forecasted amount of solar irradiance, and wherein adjusting the fixed operating train profile comprises reducing the quantity of operating liquefaction trains within the plurality of liquefaction trains.

18. The method of claim 16, wherein the real-time or forecasted amount of solar irradiance exceeds the predicted solar irradiance profile, and wherein adjusting the fixed operating train profile comprises increasing the quantity of operating liquefaction trains within the plurality of liquefaction trains.

19. The method of claim 16, wherein the fixed operating liquefaction train profile is predetermined on a seasonal basis.

20. The method of claim 16, wherein the fixed operating liquefaction train profile is predetermined on a yearly basis.
